(19) United States
(12) Patent Application Publication
(10) Pub. No.: US 2026/0095414 A1
(43) Pub. Date: Apr. 2, 2026

(54) QOE-AWARE DYNAMIC RESOURCE ALLOCATION

(71) Applicant: HEWLETT PACKARD ENTERPRISE DEVELOPMENT LP, Spring, TX (US)

(72) Inventors: SHIVANG AGGARWAL, Spring, TX (US); UMAKANT KULKARNI, Spring, TX (US); KHALED DIAB, Spring, TX (US); LIANJIE CAO, Milpitas, CA (US); FARAZ AHMED, Milpitas, CA (US); PUNEET SHARMA, Milpitas, CA (US)

(21) Appl. No.: 18/903,749

(22) Filed: Oct. 1, 2024

(51) Int. Cl. H04L 47/2408; H04L 41/14

(52) U.S. Cl. CPC H04L 47/2408; H04L 41/145

(57) ABSTRACT

Systems and methods are provided for maximizing/optimizing the quality of experience (QoE) associated with applications. A network controller may receive telemetry data from an access point (AP). A resource manager operatively connected to the network controller may estimate, based on the telemetry data, a QoE value for individual application traffic flows of one or more application traffic flows passing through the AP. An access category and traffic priority based on the estimated QoE value may be calculated, and jointly assigned to a particular application traffic flow.

### BACKGROUND

Wi-Fi networks have rapidly become an important element of today's ubiquitous connectivity, enabling a diverse range of applications and services. Such Wi-Fi networks are able to efficiently connect mobile devices, e.g., smartphones, tablets, laptops, etc. to the outside world, support a variety of services, and enable interactive experiences and seamless data exchange. One aspect of Wi-Fi's popularity is the ability to support a wide range of deployments, from small to large. A Wi-Fi network may comprise a small residential deployment in one example, and in another example, may comprise an extensive deployment in large spaces such as airports, shopping malls, campuses, and stadiums. These large deployments may serve hundreds or even thousands of mobile devices, concurrently running diverse applications. For example, a single access point (AP) in an airport may support users engaged in streaming media content, browsing the Internet, and video calls, requiring both high throughput and low latency. Similarly, stadiums connect thousands of users to a centralized controller managing millions of traffic flows for live streaming, social media, and real-time updates.

### BRIEF DESCRIPTION OF THE DRAWINGS

The present disclosure, in accordance with one or more various examples, is described in detail with reference to the following figures. The figures are provided for purposes of illustration only and merely depict typical, non-limiting aspects of such examples.

FIG. 1 illustrates an example of a network configuration in which a learning-based network controller may be implemented in accordance with some examples of the disclosed technology.

FIG. 2 illustrates a resource manager and operations associated therewith for directing a network controller to achieve QoE-aware dynamic resource allocation in accordance with some examples of the disclosed technology.

FIG. 3 is an example computing component that may be used to implement quality of experience (QoE) estimation in accordance with some examples of the disclosed technology.

FIG. 4 illustrates an example action space according to which access categories and traffic priorities are assigned for traffic flows in accordance with some examples of the disclosed technology.

FIG. 5 illustrates an example algorithm for training a QoE-aware policy agent in accordance with some examples of the disclosed technology.

FIG. 6 is an example computing component that may be used to effectuate learning-based network control in accordance with some examples of the disclosed technology.

FIG. 7 is an example computing component that may be used to implement examples of the disclosed technology.

The figures are not exhaustive and do not limit the present disclosure to the precise form disclosed.

### DETAILED DESCRIPTION

As noted above, Wi-Fi is an integral aspect of today's Internet infrastructure, and various approaches to resource allocation in a Wi-Fi network are utilized. However, conventional approaches to resource allocation in Wi-Fi are often based on Quality of Service (QoS) metrics, which do not necessarily accurately reflect a user's Quality of Experience (QoE). As used herein, resource allocation can refer to the assignment or allocation of sub-carriers in a channel bandwidth that are grouped into resource units (RUs). Such RUs can be assigned to different client devices or stations, which allows APs to serve the different client devices/stations during uplink or downlink transmissions. As will be described in greater detail below, client devices or stations that wish to send data may do so in accordance with access categories, where data belonging to the same access category can be transmitted using particular data packets, e.g., Multi-user (MU) orthogonal frequency division multiple access (OFDMA) packets.

QoE, which is distinct from Quality of Service (QoS), focuses on the experience at end-user devices and parameters impacting the end-user experience. QoE is a measure of the delight or displeasure of an end-user's experience with a service (e.g., web browsing, phone call, TV broadcast), in other words, an end-user's response to performance of a service. Additionally, while QoE focuses on the entire service experience, QoS is a description or measurement of the overall performance of a service that focuses on network infrastructure and operating parameters affecting transmission/reception at the network infrastructure. Thus, QoE can be a measure from the end-user's perspective of the overall quality of the service provided, while QoS is generally focused on the media or network itself—not the perspective of the end-user. For example, QoS parameters may include, but are not limited to, packet loss, bit rate, throughput, transmission delay, availability, jitter, etc.

It should also be noted that the IEEE 802.11 family of standards for wireless local area network (WLAN) technology, also referred to as Wi-Fi, typically include QoS extensions that can manage the prioritization of traffic based on the type of data/traffic. For example, QoS extensions for some 802.11 protocols may prioritize the transmission of voice packets and video packets. Particularly, Wi-Fi Multimedia (WMM), previously known as Wireless Multimedia Extensions (WME), is a subset of the 802.11e wireless LAN (WLAN) specification that enhances QoS on a network by prioritizing packets (traffic) according to four access categories (ACs). According to WMM, the access categories (arranged from highest priority to lowest) include:
1) Voice: By giving voice packets the highest priority, WMM enables concurrent Voice over IP (VOIP) calls with minimal latency and the highest quality possible;
2) Video: By placing video packets in the second tier, WMM prioritizes it over all other data traffic and enables support for three to four standard definition TV (SDTV) streams or one high definition TV (HDTV) stream on a WLAN;
3) Best effort: Best effort data packets consist of those originating from legacy devices or from applications or devices that lack QoS standards; and
4) Background: Background priority encompasses file downloads, print jobs and other traffic that does not suffer from increased latency.

Each of the aforementioned WMM access categories represents a different WLAN transmit and/or receive (Tx/Rx) policy. WMM also defines how Differentiated Services Code Point (DSCP) values can be mapped into those access categories. For example, when traffic flows (related data packets or a sequence of data packets going from/to a source/destination) go from a wired network to a wireless client, the WMM maps DSCP values to certain ACs so that packets which contain different DSCP values, are routed to different transmission queues. For example, on the uplink (UL) side, an application on a client device may set a DSCP value for its packets, based on the application's specifications. Prior to transmission of a traffic flow from the application (also referred to as an application flow), a flow scheduler may use the DSCP value to determine a Traffic ID (TID) that can be assigned to the traffic flow, which the flow scheduler uses to map the data packet and other data packets constituting the traffic flow, to a queue corresponding to one of the ACs. Thus, the packets, being in the different transmission queues, can be transmitted in accordance with different WLAN transmission policies of the ACs.

To address the gap between QoS and QoE noted above, examples of the disclosed technology provide adaptive systems and methods that formulate the Wi-Fi resource allocation problem as a partially-observable Markov decision process (PO-MDP) to maximize overall system QoE and QoE fairness. Examples of the disclosed technology may estimate QoE without using any application or client data. Rather, examples of the disclosed technology leverage temporal dependencies in network telemetry data to estimate QoE using machine learning models for application flows. Policies may govern the assignment of access categories and traffic priority to application flows in light of the estimated QoE, and can be dynamically adjusted to handle different classes of applications and variable network conditions. A policy agent may control this assignment of access category and traffic priority, where the policy agent can be trained in a simulation environment leveraging the same knowledge base that was developed (collected) during training of the QoE estimation models. In this way, running real clients, generating traffic through actual application sessions, and collecting both QoE and telemetry data can be avoided.

More particularly, examples of the disclosed technology are directed to a resource manager that can be integrated with an existing network controller, such as a WLAN controller. A WLAN controller typically comprises a management interface for configuring a Wi-Fi network, pushing configurations to APs, and so on. The resource manager may determine an appropriate access category and traffic priority to be assigned to an application flow. The resource manager may use a probabilistic predictive ML model to estimate the QoE of an application flow based only on telemetry data at a WLAN controller (WLAN controllers already receive telemetry data from network elements, e.g., APs, and thus are a suitable network element for integration with the resource manager), although other network elements may be leveraged. QoE metrics or characteristics are inferred by application-specific ML models using a long short-term memory (LSTM) neural network. Then, a reinforcement learning (RL) algorithm (using a double deep Q-network (DDQN) RL method along with a feed-forward neural network) can be used decide the access category and traffic priority of each application flow using the estimated QoE for an application flow. Parameters related to the radio link/channel between client devices and an AP can be controlled by the WLAN controller. Application flows can be assigned to one of three ACs (Best Effort; Video; or Voice), and in each of the access categories, the application flow can be assigned to either a low or high priority (or other set(s) of priorities as appropriate) to control packet drain rate. The assignment of access category and traffic priority to an application flow for optimizing QoE may be performed in accordance with various, possible combinations of access category and traffic priority specified as an “action space.”

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

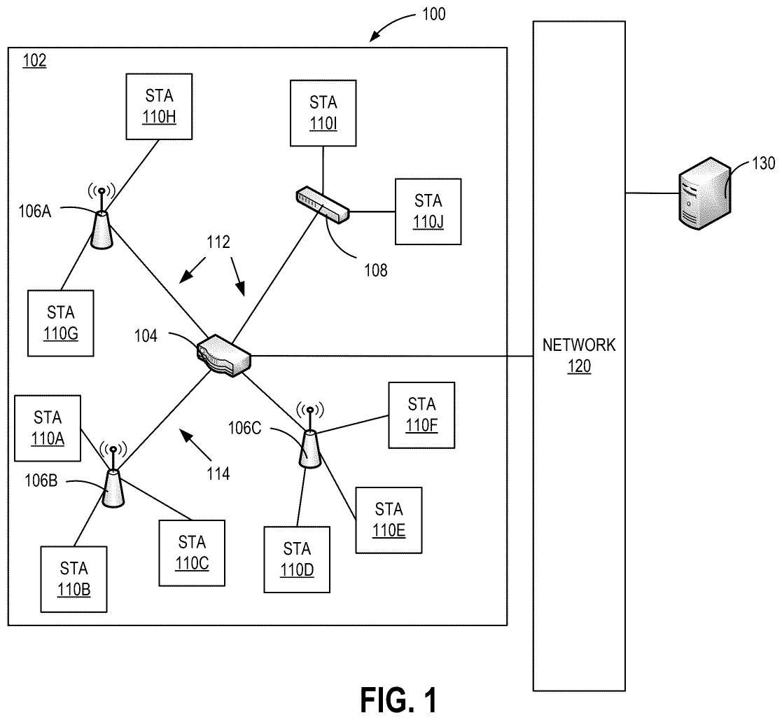

Before describing examples of the disclosed systems and methods in detail, it is useful to describe an example network installation with which these systems and methods might be implemented in various applications. FIG. 1 illustrates one example of a network configuration 100 that may be implemented for an organization, such as a business, educational institution, governmental entity, healthcare facility or other organization. FIG. 1 illustrates an example of a configuration implemented with an organization having multiple users (or at least multiple client devices 110) and at least one physical or geographical site 102. The network configuration 100 may include site 102 in communication with a network 120.

Site 102 may include a primary network, which may be an office network, home network, or other network installation, for example. The primary network may be a private network, such as a network that may include security and access controls to restrict access to authorized users of the private network. Authorized users may include employees of a company at site 102, residents of a house, customers at a business, for example.

In the example of FIG. 1, site 102 includes a controller 104, which is in communication with network 120. The controller 104 may provide communication with the network 120 for site 102. There may be other points of communication with the network 120 for site 102 in addition to controller 104. Although a single controller 104 is illustrated, site 102 may include multiple controllers and/or multiple communication points with network 120. In some examples, controller 104 may communicate with the network 120 through a router. In other examples, the controller 104 provides router functionality to the devices in site 102. In this specification, the word “tunnel” refers to an encapsulated mode of transporting data between AP and controller.

Controller 104 may be operable to configure and manage network devices, such as at site 102. Controller 104 may be operable to configure and/or manage switches, routers, access points, and/or client devices connected to a network. Controller 104 may itself be, or provide the functionality of, an access point (AP).

Controller 104 may be in communication with one or more switches 108 and/or wireless APs 106A-C. Switch 108 and wireless APs 106A-C provide network connectivity to various client devices 110A-J. Using a connection to a switch 108 or AP 106A-C, a client device 110A-J may access network resources, including other devices on the (site 102) network and network 120.

Examples of client devices may include: desktop computers, laptop computers, servers, web servers, authentication servers, authentication-authorization-accounting (AAA) servers, domain name system (DNS) servers, dynamic host configuration protocol (DHCP) servers, internet protocol (IP) servers, virtual private network (VPN) servers, network policy servers, mainframes, tablet computers, e-readers, netbook computers, televisions and similar monitors (e.g., smart TVs), content receivers, set-top boxes, personal digital assistants (PDAs), mobile phones, smart phones, smart terminals, dumb terminals, virtual terminals, video game consoles, virtual assistants, internet of things (IoT) devices, and the like.

Within site 102, switch 108 is included as one example of a point of access to the network established in site 102 for client devices 1101-J. Client devices 1101-J may connect to switch 108 and through switch 108, may be able to access other devices within the network configuration 100. Client devices 110 I-J may also be able to access network 120 through switch 108. Client devices 110 I-J may communicate with switch 108 over a wired or wireless connection. In the illustrated example, switch 108 communicates with controller 104 over a wired or wireless connection 112E.

Wireless APs 106A-C are included as another example of a point of access to the network established in site 102 for client devices 110A-H. Each of APs 106A-C may be a combination of hardware, software, and/or firmware that is configured to provide wireless network connectivity to wireless client devices 110A-H. In the example of FIG. 1, APs 106A-C can be managed and configured by controller 104. APs 106A-C communicate with the controller 104 and the network 120 over connections 112A-D, which may be either wired or wireless interfaces.

Network 120 may be a public or private network, such as the Internet, or other communication network to allow connectivity among various sites, such as site 102, as well as access to servers, such as server 130. Network 120 may include third-party telecommunication lines, such as phone lines, broadcast coaxial cable, fiber optic cables, satellite communications, cellular communications, and the like. Network 120 may include any number of intermediate network devices, such as switches, routers, gateways, servers, and/or controllers, which are not directly part of network configuration 100 but that facilitate communication between the various parts of network configuration 100, and between network configuration 100 and other network-connected entities.

In an example, the aforementioned resource manager may be embodied in server 130, and may be integrated with controller 104 to optimally assign network resources to client devices to optimize or maximize overall QoE and QoE fairness. As noted above, and as will be described in greater detail below, server 130 (the resource manager) may: extract relevant data from telemetry data obtained from an AP; infer/estimate a non-observable QoE of an application from this relevant telemetry data; and determine an optimal access category and traffic priority for application flows.

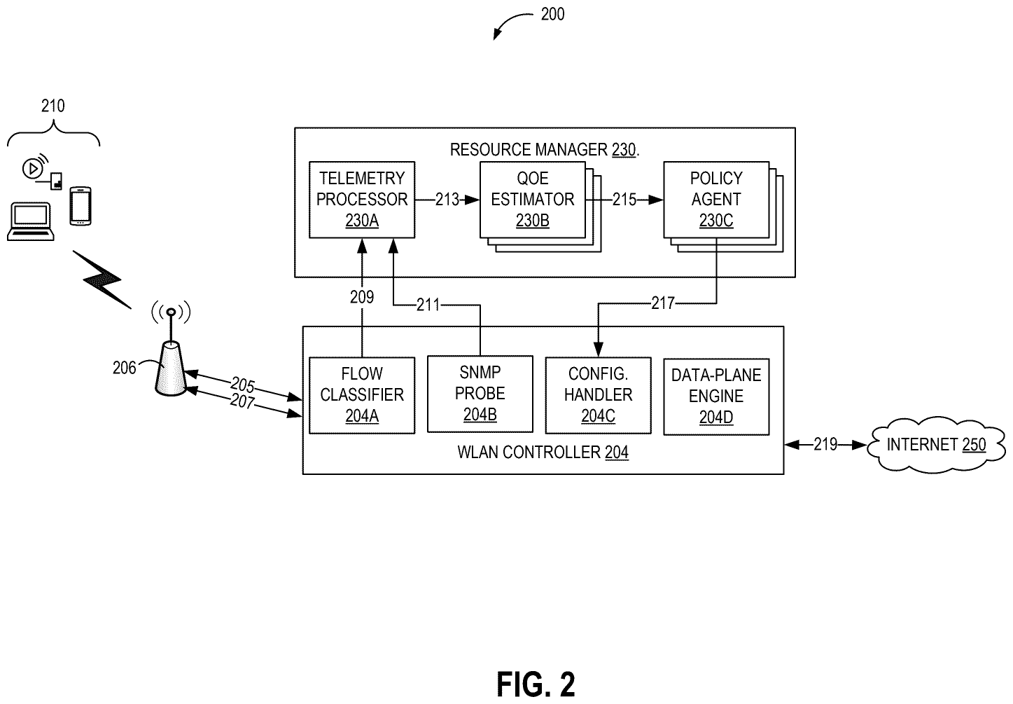

FIG. 2 illustrates a resource management system 200, and operations associated therewith for effectuating a learning-based network controller in accordance with some examples of the disclosed technology. In some examples, resource management system 200 may include one or more applications running on client devices or stations 210. An AP, such as AP 206, may serve client devices 210. Resource manager 230 may, based on telemetry data from AP 206, estimate QoE for application flows going through AP 206 based on previous or historical observations of the telemetry data. Resource manager 230 may further learn an adaptive resource allocation policy that can be used to generate or modify application flow configurations that can be pushed to AP 206 by way of a controller controlling operational aspects of AP 206, e.g., WLAN controller 204. Ultimately, data can be transmitted to, received from, travel through a data network, such as Internet 250.

As illustrated in FIG. 2, data may flow to and from client devices 210 along AP 206, to WLAN controller 204, and to Internet 250 via a data path comprising links 207 and 219. Telemetry data from AP 206 may be received by telemetry processor 230A of resource manager 230 by way of a Simple Network Management Protocol (SNMP) probe 204B of WLAN controller 204. SNMP probe 204B may use the SNMP protocol to query a device, such as AP 206, an obtain event data by acting as a trap daemon and monitoring SNMP traps and events relating to, in this example, raw telemetry data. Raw telemetry data can include user, system, and radio metrics or operating characteristics, such as radio link parameters between client devices 210 and AP 206, metrics related to application traffic, wireless capabilities, underlying Wi-Fi configuration, and overall system statistics. The raw telemetry data can be passed from SNMP probe 204B to telemetry processor 230A. Telemetry processor 230A can extract relevant data from the raw telemetry data, and if needed, convert the data into requisite formats. It should be noted that the relevant data extracted from the raw telemetry data tends to be implementation-specific, and can vary depending, for example, on application or traffic type at issue, network characteristics, etc. Table 2, discussed in greater detail below, presents example features representative of such relevant data.

It is again emphasized that this telemetry data is the only data to which resource manager 230 has access. No data from client devices 210 nor the applications running thereon are needed or used by resource manager 230.

A predictive ML model can be trained for each application class, and such predictive ML models can be loaded into memory (not shown) of resource manager 230. It should be understood that application class can refer to typical QoS classes for Layer 2 and Layer 3, e.g., a web-browsing/email application class, a video conferencing application class, a YouTube® video streaming application class, an HD video streaming (Netflix®, Hulu®) application class, and so on. Application classes are typically associated with requisite throughput parameters, e.g., 500 Kbps to 1 Mbps for web-browsing/email, and 2-5 Mbps for HD video streaming, and so on. In some examples, application classes of interest are video streaming, video conferencing, and file transfer applications, but any application classes can be considered as desired. Thus, a predictive ML model may be generated, trained, and loaded into resource manager 230. These predictive ML models may be embodied by separate instances of QoE estimator 230B. Thus, when data packets arrive at WLAN controller 204 from AP 206, flow classifier 204A can identify an appropriate application class corresponding to the data packets. The identified application class can be provided to telemetry processor 230A. The processed telemetry data from telemetry processor 230A can be forwarded to the corresponding application class instances of QoE estimator 230B. The relevant instance(s) of QoE estimator 230B can estimate the QoE of the application flow reflected by the processed telemetry data, and the estimated QoE information or data can be forwarded on to policy agent 230C.

Policy agent 230C may compute the access category and traffic priority for application flows based on estimated QoE metrics (determined as described above) to maximize the overall QoE and the QoE fairness. In some examples, multi-agent RL can be used, where a specific policy agent or policy agent instance serves a specific application class, e.g., video streaming, video conferencing, or file transfer. The instances of policy agent 230C can modify application flow configurations associated with their respective application class via an AP configuration handler 204C, which then pushes these policies to the AP, for example AP 206.

Data plane engine 204D may handle the routing of data packets, e.g., a table or other mechanism that can be used to determine, e.g., a destination path of an incoming data packet or the data path through the network.

It should be noted that the exchange of access category and traffic priority information between policy agent 230C and configuration handler 204C, the transmission of raw metrics (telemetry) data from SNMP prove 204B and application class information from flow classifier 204A to telemetry processor 230A may occur using, e.g., the transmission control protocol (TCP) and the requisite TCP interfaces therebetween. The transmission of processed telemetry data from telemetry processor 230A to QoE estimator 230B, and the transmission of application class-specific QoE from QoE estimator 230B to policy agent 230C can be done over shared memory connections. As used herein, a shared memory connection can refer to an area of shared memory (not shown) used as a channel through which telemetry processor 230A, QoE estimator 230B, and policy agent 230C may communicate with one another. The data exchange between AP 206 and WLAN controller 204 can be performed over an OpenFlow interface.

Estimating QoE poses challenges. Telemetry data is heterogeneous, and can vary greatly in scale and format. In addition, telemetry data can include instantaneous values, cumulative statistics, and derived features, each with potential outliers and different domains, ranges, and distributions. Additionally, the relationship between telemetry and QoE is non-linear (and thus, complex) and is based on hidden or latent features. Ultimately, QoE metrics or characteristics are often impacted by temporal context and dependencies of the telemetry data. That is, the QoE of an application can depend on the history of telemetry. Therefore, examples of the disclosed technology are directed to accurate modeling of the temporal and hidden relationship between telemetry and QoE metrics based on historical telemetry data as noted above.

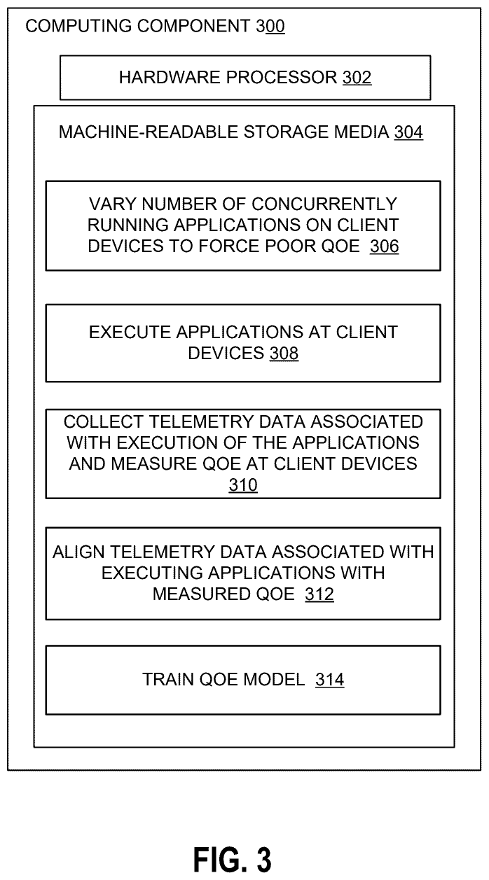

FIG. 3 illustrates an example computing component 300 that may be used to implement QOE estimation in accordance with some examples of the disclosed technology. Referring now to FIG. 3, computing component 300 may be, for example, a server computer, a controller, or any other similar computing component capable of processing data. In the example implementation of FIG. 3, the computing component 300 includes a hardware processor 302, and machine-readable storage media 304. In some examples, computing component 300 may be an embodiment of resource manager 230 (or a component(s) thereof, e.g., QoE estimator 230B).

Hardware processor 302 may be one or more central processing units (CPUs), semiconductor-based microprocessors, and/or other hardware devices suitable for retrieval and execution of instructions stored in machine-readable storage media 304. Hardware processor 302 may fetch, decode, and execute instructions, such as instructions 306-316, to control processes or operations for application flow-specific QoE estimation. As an alternative or in addition to retrieving and executing instructions, hardware processor 302 may include one or more electronic circuits that include electronic components for performing the functionality of one or more instructions, such as a field programmable gate array (FPGA), application specific integrated circuit (ASIC), or other electronic circuits.

Machine-readable storage media, such as machine-readable storage media 304, may be any electronic, magnetic, optical, or other physical storage device that contains or stores executable instructions. Thus, machine-readable storage media 304 may be, for example, Random Access Memory (RAM), non-volatile RAM (NVRAM), an Electrically Erasable Programmable Read-Only Memory (EEPROM), a storage device, an optical disc, and the like. In some examples, machine-readable storage media 304 may be a non-transitory storage medium, where the term “non-transitory” does not encompass transitory propagating signals. As described in detail below, machine-readable storage media 304 may be encoded with executable instructions, for example, instructions 306-316.

Hardware processor 302 may execute instruction 306 to vary a number of concurrently running applications on client devices to force poor QoE.

In some examples of the disclosed technology, telemetry data can be sequentially processed in order to capture long-term dependencies, while maintaining a reasonably long context over extended periods. Specifically, examples of the disclosed technology model QoE estimation using a long short-term memory (LSTM) network that can capture trends that develop over time, and maintain representative gradient values as context length is increased. It should be noted that modeling QoE estimation can be accomplished using other ML model designs, but the prediction accuracy can vary. A

In order to train an application class-specific QoE estimation model in accordance with examples of the disclosed technology, applications in a Wi-Fi testbed can be executed. Telemetry data and the exact QoE for video streaming, video conferencing, and file transfer can be collected pursuant to application execution. That is, an LSTM model can receive AP telemetry data as input, and the LSTM model can output the estimated QoE for the applicable application class.

The collection of telemetry data and QoE estimation can be performed under diverse network conditions ranging from underloaded to overloaded scenarios by systematically varying Wi-Fi configurations. An example of possible Wi-Fi control parameters that can be used to produce varied Wi-Fi configurations are set forth in Table 1. Moreover, the number of concurrent applications being executed can be varied from 1 to n, where n is chosen such that all concurrently running application instances will congest the network, leading to poor QoE. Application sessions can be distributed, e.g., evenly among a plurality of Wi-Fi client devices, for example, four client devices.

TABLE 1

| Frequency Band | | PHY/MAC Mode | Channel Width | | Access Category | Traffic Priority |
|---|---|---|---|---|---|---|
| 2.4 | GHz | High Throughput (HT) | 20 | MHz | Background (BK) | High Priority (HQ) |
| 5 | GHz | Very HT (VHT) | 40 | MHz | Best Effort (BE) | Low Priority (LQ) |

| | | | |
|---|---|---|---|
| High Efficiency (HE) | 80 | MHz | Video (VI) |
| | 160 | MHz | Voice (VO) |

Hardware processor 302 may execute instruction 308 to execute the applications at the client devices. For each application session, the applications can be executed, in this example, four client devices. The duration of an application session can vary, but in one example, an application session can be set for 200 seconds. Execution of an application can be repeated as desired, e.g., twice in some examples, to increase the size and diversity of the dataset.

Hardware processor 302 may execute instruction 310 to collect telemetry data associated with execution of the applications, and measure the QoE of the applications at the client devices. Using the above-described application execution approach, extensive telemetry data can be collected, encompassing applications that run for a total of 251 hours, for example, across all client devices, for the three application classes (video streaming, video conferencing, and file transfer applications), resulting in over 226,000 data points. The telemetry data can be collected in accordance with some temporal specification, e.g., periodically, at every four seconds.

Moreover, QoE can be measured during the execution of the applications at the client devices. The QoE metrics of applications can be calculated within every interval, while the QoE metrics can be normalized against a maximum achievable QoE value for each application. In this way, QoE values across application classes can be compared. In particular, and although subjective metrics are typically the most accurate indicators of a user's experience, the collection of subjective metrics is unfeasible for large numbers of system configurations. Accordingly, objective quality metrics can be used, which reasonably approximate perceived quality by an end user.

For calculating video stream QoE, Model Predictive Control (MPC)-based algorithms can be used, where the QoE metric is a function of: the quality of each video chunk, the quality variation between successive chunks, rebuffering time, and startup delay. The rationale behind approach is that users tend to prefer uninterrupted video playback (without stalling) once a video starts playing, and frequent changes in video quality between chunks are undesirable. Using MPC, the best possible QoE is achieved throughout a video streaming session.

In order to measure video conferencing QoE, focus is placed on the following metrics: audio jitter; audio packet loss; video packet loss; and sent video packets. The rationale for considering such metrics is that end users generally consider choppy real-time sound or video frames that are out of sync with audio to be annoying and undesirable. The best possible QoE for the video conferencing application is achieved with the highest resolution video, the maximum possible frame rate, and minimal jitter and packet loss. For video conferencing applications, QoE values are normalized against this best possible QoE score. To map these QoE metrics to a four-second interval, the QoE values can be averaged over four seconds, and a single QoE value can be reported.

As to file transfer QoE, because QoE is computed at every interval of time (as described above) (rather than simply using file transfer completion time), the number of Bytes transferred from server to client in one second can be recorded. This data can then be averaged over a four-second interval to compute the QoE for that period, aligning it with the specified, four-second telemetry collection interval. The rationale for computing file transfer QoE in this way is that end users tend to prefer that file transfers are completed in the shortest time possible, which can be achieved if a server consistently/continuously sends large amounts of data to a recipient.

Hardware processor 302 may execute instruction 314 to align telemetry data associated with execution of the applications with the measured application flow-specific QoE. In some examples, the QoE and telemetry data are synchronized based on their timestamps. In addition, since each application may report its QoE at a different rate than that of telemetry, these measurements can be aligned by averaging the QoE metrics over each four-second interval. This ensures that the telemetry data at time t accurately reflects the system state, by mapping the average QoE metric from t−4 to t seconds to the corresponding telemetry.

Moreover, aligning the telemetry data can encompass data normalization. In the case of video streaming applications, each (aforementiond) video chunk's QoE can be normalized against the best possible QoE score. The QoE values range from negative infinity to one, although, experimentally, QoE generally does not go below minus one. Thus, the range of QoE values can be restricted between minus one to one. These QoE values between zero and one can be normalized using a min-max normalization method. This normalized QoE is reported for each video chunk, corresponding to a four-second interval. It should be noted a video streaming application is run in the balanced mode in order to maintain a balance between avoiding re-buffering (stalls) and avoiding instability (changes in the video quality). This achieves minimal re-buffering and stable quality.

As for video conferencing applications, the best possible QoE is generally achieved with the highest resolution video, the maximum possible frame rate, and minimal jitter and packet loss. For video conferencing applications, QoE values are normalized against this best possible QoE score.

As for file transfer applications, the best achievable QoE for file transfer can be determined using an optimal Wi-Fi configuration, which includes a 160 MHz channel using the 5 GHz frequency band and HE physical interface. At this setting, the above-mentioned server can transfer the maximum number of Bytes to the client device, representing the best achievable QoE. QoE for each four-second interval can be normalized against this maximum file transfer QoE score.

Hardware processor 302 may execute instruction 314 to train a QoE model, recalling that a QoE ML model can be developed and implemented for each application class. In order to train an application class-specific QoE model, an LSTM network can be constructed using an input layer of, e.g., 257 telemetry data items, and three stacked LSTM layers, where the first, second, and third layers have 256, 128, and 64 hidden units, respectively. The LSTM layers can be followed by a dense output layer to compute the estimated QoE metric. The application class-specific QoE model can be trained using the Adam optimizer and mean squared error (MSE) loss function. The dataset can be divided into training, validation, and test datasets using split ratios of 60%, 20%, and 20%, respectively. The training process may comprise 50 epochs with a batch size of 32. Table 2 (below) highlights examples features identified by the model using the permutation feature importance method for QoE estimation across all applications.

TABLE 2

| Feature | Description |
|---|---|
| Delay | End-to-end delay |
| RX Unicast Data Frames | Number of unicast frames received |
| TX Data Frames MCS-X | Total number of data frames transmitted |
| | at rate of MCS X |
| Last SNR | Last recorded signal-to-noise ratio |
| Last RX SNR | SNR of the last data packet received |
| | from the client |
| Last ACK SNR | SNR of the last acknowledgment packet |
| | sent by the client |
| Current Noise Floor | Residual background noise detected by |
| | an AP |
| Channel busy | Percentage of time the radio channel was |
| 1/4/64 Sec | busy in the last 1/4/64 seconds |
| PS State | Power-save state, showing if the |
| | AP/channel/link is in the awake or power- |
| | save state |
| TX Retries | Number of packets that the AP had to |
| | resend to the client due to a |
| | transmission failure |
| TX RTS Failed | Number of Ready To Send (RTS) frames |
| | that were not successfully transmitted |
| Health | Quality of the link between the client |
| | and the radio |

Although the state of the PO-MDP is estimated using QoE estimator 230B, the transition probability remains challenging to model due to the complex relationship between actions taken and observed state. Examples of the disclosed technology address the complexity of using RL for a large search space, and possible lack of sufficient training data by using an RL approach that can explore various possibilities in the search space while efficiently utilizing collected state. The exploration process can be controlled to speed up model convergence, while a DNN handles the high-dimensional state-action space in the Wi-Fi setting, caused by varying application classes, dynamic network conditions, and diverse client capabilities. As noted above, policy agent 230C may leverage a DDQN RL method coupled with a feed-forward neural network to handle high-dimensional space, and a replay buffer to improve sample efficiency.

More particularly, the Q-network denoted by Q (s, a; θ) is a neural network that approximates the action-value function, where s represents the state, a represents the action, and θ represents the network parameters. The target Q-network Q′ is a copy of the Q-network that is periodically updated to stabilize the learning process and minimize potential overestimation of the Q values. During training, the Q-value is updated as follows:

$$( Eq . 1 )$$

$$Q ( {s}_{t} , {a}_{t} ) ← Q ( {s}_{t} , {a}_{t} ) + α [ {r}_{t} + γ {Q}^{′} ( {s}_{t + 1} , arg {max}_{{a}^{′}} Q ( {s}_{t + 1} , {a}^{′} ; θ ) {θ}^{′} ) - Q ( {s}_{t} , {a}_{t} ; θ ) ] ,$$

where sₜ is the current state at time t, at is the action taken at time t, a′ is the action maximizing the next state's Q-value, rₜ is the reward received at time t, sₜ+1 is the next state at time t+1, θ′ is the target Q-network parameters, a is the learning rate, and γ is the discount factor. Actions may be selected using Boltzmann exploration, which assigns probabilities to each action based on their Q-values as:

$$P ( a ) = \frac{{e}^{{Q}_{t} ( {s}_{t} , a ) / T}}{{\sum }_{i = 1}^{n} {e}^{{Q}_{t} ( {s}_{t} , {a}^{′} ) / T}} , \qquad ( Eq . 2 )$$

where T is the temperature parameter that controls the exploration-exploitation trade-off.

The loss function used to train the Q-network is the mean squared error (MSE) between the predicted Q-values and the target Q-values:

$$L ( θ ) = E [ {( {r}_{t} + γ {Q}^{′} ( {s}_{t + 1} , arg {max}_{{a}^{′}} Q ( {s}_{t + 1} , {a}^{′} ; θ ) {θ}^{′} ) - Q ( {s}_{t} , {a}_{t} ; θ ) )}^{2} ] . \qquad ( Eq . 3 )$$

As noted above, examples of the disclosed technology control the parameters related to the radio link between Wi-Fi client devices and the AP. Typical WLAN controllers enable configuring flow-level, radio-level, and device-level parameters. Because configuring radio-level and device-level parameters are associated with restarting the AP or devices, resource manager 200 operates to configure flow-level parameters that can be modified during run-time. Run-time modification in accordance with examples of the disclosed technology provide for the ability to achieve a desired improvement to a flow's QoE while maintaining QoE fairness across, e.g., multiple flows. Such parameters can be computed by resource manager 200, and ultimately modified via configuration handler 204C of WLAN controller 204.

Access category and traffic priority can be assigned to an application flow jointly or in combination. When assigning the access category aspect to an application flow, the application flow's application class need not be limited to a specific access category. Instead, policy agent 230C can assign incoming application flows to any access category based on the learned policy, in order to adapt to application heterogeneity and diverse network conditions. As already noted above, in some examples, application flows can be assigned to any of three access categories: Best Effort (BE), Video (VI), and Voice (VO). Moreover, policy agent 230C may assign either a low priority (LQ) or a high priority (HQ) to each flow, which controls the drain rate of packets. These actions (i.e., the assignment of the combination of AC/traffic priority for each application), can be performed in accordance with a given periodicity, such as every 16 seconds. Such periodic performance of actions allows for policy agent 230C (and resource manager 230 as a whole) to dynamically adapt to changing network conditions. The duration/periodicity of performance can vary depending on, e.g., the processing capability and speed of WLAN controller 204's processor (not shown in FIG. 2).

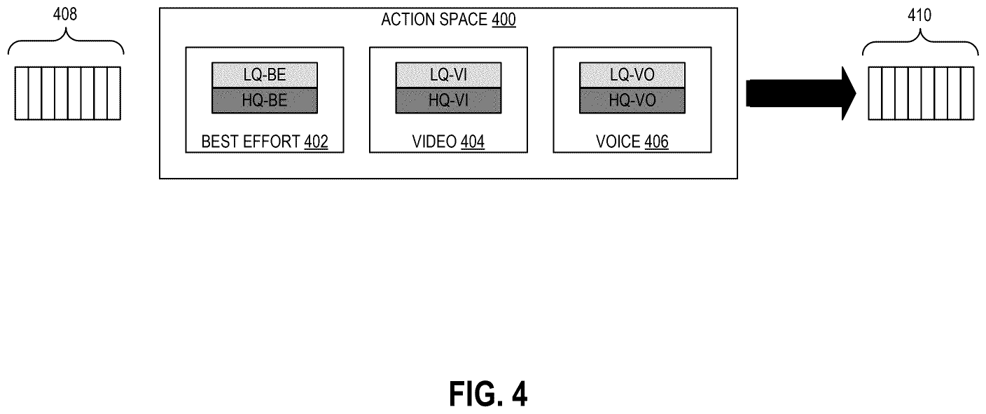

FIG. 4 illustrates an example action space 400 the sets forth access category/traffic priority combinations to which incoming application flows may be assigned, where an “action” as used herein can refer to the act of assigning possible access category/traffic priority combinations to application flows. By combining the low and high priority queues (LQ/HQ) with the access categories as shown in FIG. 4, the action space 400, in accordance with an example of the disclosed technology, comprises, the following six possible action combinations: LQ+BE and HQ+BE for the BE access category 402; LQ+VI and HQ+VI for the VI access category 404; and LQ+VO and HQ+VO for the VO access category 406. Incoming data packets representative of one or more application flows 408 can be assigned by policy agent (such as policy agent 230C) a particular access category/traffic priority combination set forth in action space 400. By virtue of the policy agent periodically (e.g., every 16 seconds) assigning an access category/traffic priority to an application flow, as described above, the application flow configurations are changed/updated via configuration handler 204C. Configuration handler 204C may then push these policies to the AP, e.g., AP 206, through which the applications flows are traversing.

It should be noted that the smallest unit on which a policy agent takes action (referred to as state space) is a 5-tuple application flow traversing an AP. Given the complexity and volume of data available within the controller database, comprising thousands of metrics, identifying which of these metrics significantly impact QoE estimation can be challenging. To ensure comprehensive coverage, all available metrics allowing the QoE estimator to select a pertinent subset and accurately estimate the QoE are considered in accordance with examples of the disclosed technology.

AP telemetry data can be categorized as one of the following three types of data: application-related data, client-specific data, and access point-specific data. Application-related data can include metrics such as flow-specific throughput, transport protocol of the flow, and TX/RX bytes. Client-specific data can encompass the wireless capabilities of the client, e.g., signal-to-noise ratio (SNR), PHY/MAC interface details, channel width, and access category. Access point-specific data may involve system-specific metrics such as overall packet loss, packets dropped, buffer TX/RX metrics, and various radio metrics. The above metrics are merely examples intended to provide context as many other relevant metrics can be considered within each data category.

As noted above, a policy agent configured in accordance with examples of the disclosed technology utilize a DDQN RL method coupled with a feed-forward neural network. In some examples, the reward function of the DDQN is configured to maximize overall QoE and to maximize QoE fairness. Due to the aforementioned use of a multi-agent RL (recalling that different policy agent instances serve different application classes), in addition to the state, each policy agent instance receives: (1) the mean QoE of all other applications; and (2) the deviation of the particular application's QoE from the mean QoE. After taking an action aₜ at state sₜ, the reward function can be defined as:

$$R ( {s}_{t}^{app} , {a}_{t}^{app} ) = {w}_{QoE} * {QoE}_{app} - {w}_{mean} * {\overline{QoE}}_{others} - {w}_{deviation} * deviation , \qquad ( Eq . 4 )$$

where QoEₐₚₚ is the QoE of a current application flow, Q̅o̅E̅ₒₜₕₑᵣₛ is the mean QoE of all other application flows, and deviation=|QoEₐₚₚ−Q̅o̅E̅_{system}| is the deviation of the current application's QoE from the system-wide, mean QoE, where

$${\overline{QoE}}_{system} = \frac{1}{N} {\sum }_{i = 1}^{N} {QoE}_{i}$$

is the system-wide mean QoE for N application flows. The weights w_{QOE}, wₘₑₐₙ, and w_{deviation} are used to adjust the sensitivity of the application QoE to the Wi-Fi environment, allowing the reward function to be tailored to the specific needs of different applications. This function maximizes the QoE of the current application, balances it against the mean QoE of all other applications, and maximizes QoE fairness by minimizing deviation in QoE metrics.

Further regarding the policy agent of the resource manager, training the policy agent in Maestro poses several challenges. The training process involves access to state variables, execution of actions, and observation of rewards and next states. Achieving this in a real/working Wi-Fi setup or environment requires running real clients, generating traffic through actual application sessions, and collecting both QoE and telemetry data. That is, obtaining a sufficient number of diverse samples for the policy agent to learn an access category/traffic priority assignment policy is impractical due to the complexity and variability of actual network conditions. In addition, these real Wi-Fi conditions cannot be easily integrated with current RL environments, not to mention that exploring all possible state-action combinations is infeasible, as it requires an excessive amount of time and resources.

Therefore, in accordance with an example of the disclosed technology, a simulation environment that leverages an extensive knowledge base already collected during the training of the QoE estimator can be utilized for training the policy agent. This knowledge base includes telemetry data and the corresponding QoE values, and enables the resource manager to simulate the training process for the policy agent efficiently.

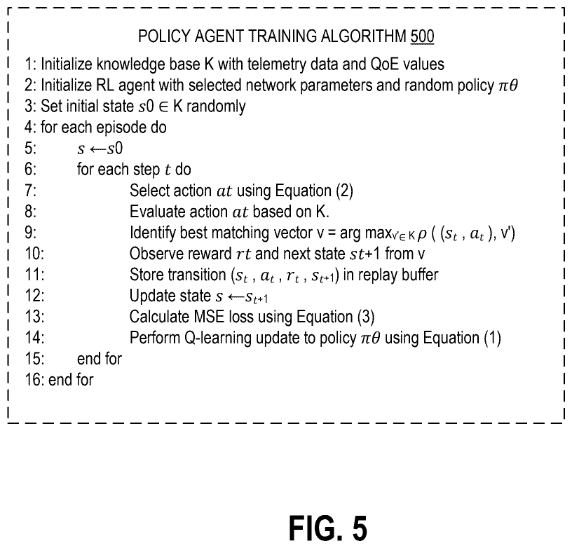

FIG. 5 illustrates an example algorithm 500 that represents the iterative learning process employed by the policy agent in a simulation environment. The policy agent starts from a random state within the knowledge base. Upon selecting an action based on this state, algorithm 500 evaluates the action by comparing it to the knowledge base. Algorithm 500 uses the Pearson correlation coefficient ρ to find a best matching vector, v. That is, by maximizing ρ, algorithm 500 identifies the best matching vector, v, that corresponds to the current state, Wi-Fi configuration, action taken, and reward received. This matching vector, v, represents the next state, allowing the policy agent to continue its learning process iteratively.

In order to estimate the weights of the reward function in Eq. 4, and the temperature value of the Boltzmann exploration in Eq. 2, five different representative sets of reward function weights, and ten temperature values ranging from 0 to 1 with increments of 0.1 may be used. A combination of these values can be fed one at a time to algorithm 500. Final weight and temperature values based on the loss function can be selected.

It should be noted that the loss function of RL training follows a behavior similar to function L(t)=α*t*e−βt, where t is the training time or the number of episodes, α is a scaling factor that determines the height of the peak, and β is a factor that controls the rate of decrease after the peak. This is because the function represents the expected loss values over time. The loss value initially rises as the policy agent explores, reaches a peak, and then gradually decreases to zero as the policy agent learns and optimizes its (access category/traffic priority assignment) policies. The reward weights and temperature values can be chosen by fitting this function to the observed loss values.

Table 4 lists an example set of optimized reward weights and temperature values for each application class, based on a state size of 257, and an action (space) size of six, a hidden layer size of 128, a discount factor of 0.99, batch size of 32, an Adam optimizer, a learning rate of 0.0001, and a replay buffer of 10,000.

TABLE 4

| Application | w_{QoE} | wₘₑₐₙ | w_{deviation} | T |
|---|---|---|---|---|
| Video streaming | 0.2 | 0.6 | 0.2 | 0.4 |
| Video conferencing | 0.2 | 0.2 | 0.6 | 0.6 |
| File transfer | 0.34 | 0.33 | 0.33 | 0.8 |

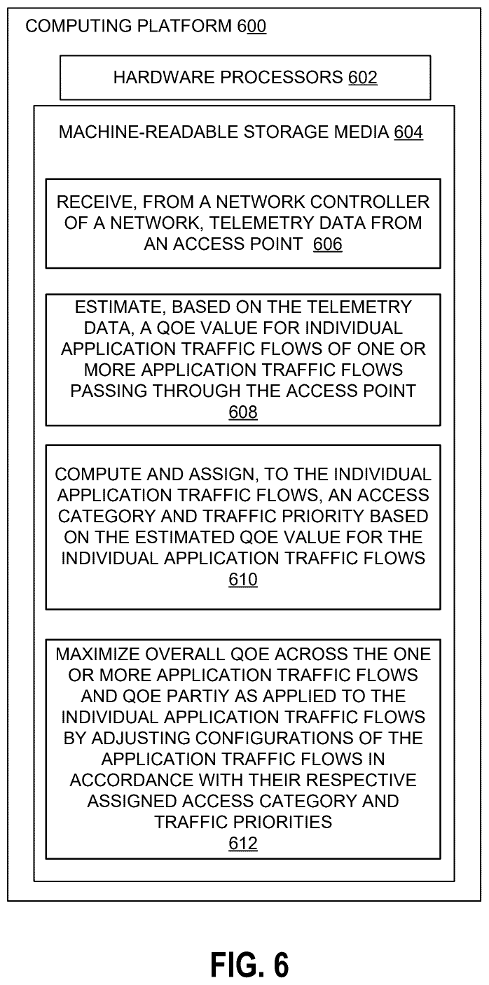

FIG. 6 illustrates an example computing component 600 that may be used to implement QOE-aware dynamic resource allocation in accordance with some examples of the disclosed technology. Referring now to FIG. 6, computing component 600 may be (similar to computing component 300), for example, a server computer, a controller, or any other similar computing component capable of processing data. In the example implementation of FIG. 6, also like computing component 300, computing component 600 includes a similar hardware processor 602, and a similar machine-readable storage media 604. In some examples, computing component 600 may be an embodiment of resource manager 230, a server, such as server 160, etc.

As described in detail below, machine-readable storage media 604 may be encoded with executable instructions, for example, instructions 606-612.

Hardware processor 602 may execute instruction 606 to receive, at a network controller, telemetry data from an AP. As previously discussed, client devices may be served by an AP while running applications, such as video streaming applications, file transfer applications, and the like. Unlike other systems and methods that require collecting, e.g., internal application state information, or other data from the client device(s) or the application(s), examples of the disclosed technology are able to estimate QoE solely based on telemetry data associated with the running of applications on the client devices whose data packets/traffic traverse the AP. The telemetry data, as discussed above, may be parsed to extract relevant data, and may be normalized/converted to account for variances between the types

Hardware processor 602 may execute instruction 608 to estimate, based on the telemetry data, a QoE value for individual application traffic flows of the one or more application traffic flows passing through the AP. A telemetry processor that intakes the telemetry data from the AP and performs the aforementioned extraction of relevant data and data normalization may pass the relevant data to a QoE estimator. The QoE estimator may comprise a plurality of QoE estimator instances used to estimate a QoE for the application(s) running at the client device(s) as evidenced by the received telemetry data according to an application class to which the application(s) are categorized. The QoE estimator instances comprise ML models that are trained to accurately model the temporal and hidden relationship between telemetry data and QoE metrics. That is, the QoE estimator instances infer “non-observable” QoE metrics. In some examples, an LSTM network may be constructed for training these QoE ML models, where the training data is derived from telemetry and measured QoE information under diverse network conditions, and wherein the telemetry data and measured QoE information are aligned, e.g., based on timestamps.

Hardware processor 602 may compute and assign, to the individual application traffic flows, an access category and traffic priority based on the estimated QoE value for the individual application traffic flows. In some examples, a plurality of policy agents comprising ML models directed, again, to specific application classes, are trained to maximize overall QoE and QoE fairness within the network and AP/client devices. Reinforcement learning can be used to perform this assignment. Ultimately, the policy agent directed to an application class assigns an action to application flows belong to its application class. The action comprises the assignment of both access category and traffic priority to application flows. It should be noted that application flows can be assigned to any access category based on the policies that are learned by the policy agent instances. It should be further noted that the policy agent instances can be trained in a simulated environment to avoid the operational costs associated with running actual client devices and applications, and varied operation of a Wi-Fi network. The simulation environment may leverage the already-existing knowledge bases that includes received telemetry data and corresponding QoE values.

Hardware processor 602 may execute instruction 612 to maximize overall QoE across the one or more application traffic flows and QoE parity as applied to the individual application traffic flows by adjusting configurations of the individual application flows in accordance with their respective assigned access category and traffic priorities. As noted above, in some examples, configuration actions can occur/be performed in accordance with a given periodicity to account for dynamic network conditions. A configuration handler operates to push the policies/configurations determined/assigned by the policy agent instances to the AP.

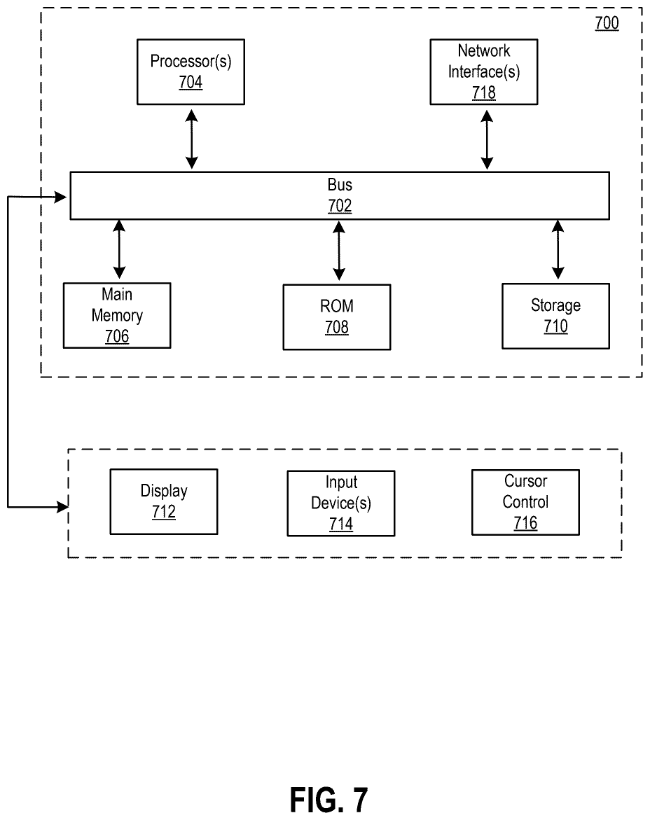

FIG. 7 depicts a block diagram of an example computer system 700 in which various examples of the disclosed technology described herein may be implemented. The computer system 700 includes a bus 702 or other communication mechanism for communicating information, one or more hardware processors 704 coupled with bus 702 for processing information. Hardware processor(s) 704 may be, for example, one or more general purpose microprocessors.

The computer system 700 also includes a main memory 706, such as a random access memory (RAM), cache and/or other dynamic storage devices, coupled to bus 702 for storing information and instructions to be executed by processor 704. Main memory 706 also may be used for storing temporary variables or other intermediate information during execution of instructions to be executed by processor 704. Such instructions, when stored in storage media accessible to processor 704, render computer system 700 into a special-purpose machine that is customized to perform the operations specified in the instructions.

The computer system 700 further includes a read only memory (ROM) 708 or other static storage device coupled to bus 702 for storing static information and instructions for processor 704. A storage device 710, such as a magnetic disk, optical disk, or USB thumb drive (Flash drive), etc., is provided and coupled to bus 702 for storing information and instructions.

The computer system 700 may be coupled via bus 702 to a display 712, such as a liquid crystal display (LCD) (or touch screen), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. In some examples, the same direction information and command selections as cursor control may be implemented via receiving touches on a touch screen without a cursor.

The computing system 700 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

Elements comprising a QoE-aware dynamic resource allocation system, e.g., that of FIG. 2, such as a resource manager, a network orchestrator, etc. may be embodied by computer system 700.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 710. Volatile media includes dynamic memory, such as main memory 706. Non-transitory media is distinct from but may be used in conjunction with transmission media. Transmission media participates in transferring information between non-transitory media.

The computer system 700 also includes a communication interface 718 coupled to bus 702. Network interface 718 provides a two-way data communication coupling to one or more network links that are connected to one or more local networks. For example, communication interface 718 may be an integrated services digital network (ISDN) card, cable modem, satellite modem, or a modem to provide a data communication connection to a corresponding type of telephone line. Wireless links may also be implemented. In any such implementation, network interface 718 sends and receives electrical, electromagnetic or optical signals that carry digital data streams representing various types of information.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed examples. The performance of certain of the operations or processes may be distributed among computer systems or computers processors, not only residing within a single machine, but deployed across a number of machines.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method comprising:
receive, from a network controller of a network, telemetry data from an access point (AP);
estimate based on the telemetry data, a quality of experience (QoE) value for individual application traffic flows of one or more application traffic flows passing through the AP;
compute and assign, to the individual application traffic flows, an access category and traffic priority based on the estimated QoE value;
maximize overall QoE across the one or more application traffic flows and QoE parity as applied to the individual application traffic flows by adjusting configurations of the individual application traffic flows in accordance with their respective assigned access category and traffic priorities.

2. The method of claim 1, wherein the received telemetry data comprises raw telemetry data including user metrics, network metrics of the network, and radio metrics of one or more radios operating in the AP.

3. The method of claim 2, further comprising, processing the raw telemetry data to extract QoE estimation-relevant telemetry data.

4. The method of claim 3, wherein the processing of the raw telemetry data comprises processing sequential telemetry data.

5. The method of claim 1, wherein the estimation of the QoE value comprises identifying an application class associated with packets of the one or more application traffic flows received by the network controller.

6. The method of claim 5, further comprising, using the identified application class to apply an application class-specific prediction model corresponding to the identified application class to estimate the QoE value in based on the telemetry data.

7. The method of claim 6, wherein the application class-specific prediction model comprises a long short-term memory (LSTM) neural network.

8. The method of claim 6, further comprising, training the application class-specific prediction model using collected telemetry data and measured QoE under diverse network conditions including underloaded and overloaded network conditions.

9. The method of claim 8, further comprising synchronizing the collected telemetry data with the measured QoE based on respective timestamps associated with the collected telemetry data and the measured QoE.

10. The method of claim 1, wherein the computing and assignment, to the individual application traffic flows, of an access category and traffic priority based on the estimated QoE value, is performed by application class-specific policy agents.

11. The method of claim 1, wherein the application class-specific policy agents use a double deep Q-network (DDQN) reinforcement learning (RL) algorithm coupled with a feed-forward neural network.

12. The method of claim 11, wherein the computing and assignment, to the individual application traffic flows, of an access category and traffic priority based on the estimated QoE value, comprises assigning the access category and traffic priority jointly in accordance with an action space comprising possible access category and traffic priority combinations.

13. The method of claim 10, further comprising training the application class-specific policy agents in a simulation environment.

14. A system, comprising:
a processor; and
a memory unit including instructions that when executed, cause the processor to:
receive telemetry data from an access point (AP);
estimate based on the telemetry data, a quality of experience (QoE) value for each application traffic flow of a plurality of application traffic flows traversing the AP;
compute, for each application traffic flow, an access category and a traffic priority, based on the estimated QoE value;
jointly assign the computed access category and traffic priority to each application flow; and
push a configuration comprising the jointly assigned access category and traffic priority to a network controller to be forwarded to the AP for reconfiguring the AP to process subsequent data packets belonging to each of the application traffic flows in accordance with the jointly assigned access category and traffic priority.

15. The system of claim 14, wherein the instructions that when executed cause the processor to estimate the QoE value comprises instructions that when executed, further cause the processor to:
identify an application class associated with data packets of the one or more application traffic flows received by the network controller; and
apply an application class-specific prediction model corresponding to the identified application class to estimate the QoE value based on the telemetry data.

16. The system of claim 15, wherein the application class-specific prediction model comprises a long short-term memory (LSTM) neural network.

17. The system of claim 14, wherein the memory unit includes further instructions that when executed, further cause the processor to train the application class-specific prediction model using collected telemetry data and measured QoE under diverse network conditions including underloaded and overloaded network conditions.

18. The system of claim 14, wherein the instructions that when executed cause the processor to compute and jointly assign the access category and traffic priority, comprise further instructions that when executed, further cause the processor to execute policy agent instances specific to each identified application class.

19. The system of claim 18, wherein the policy agent instances agents use a double deep Q-network (DDQN) reinforcement learning (RL) algorithm coupled with a feed-forward neural network to compute the access category and traffic priority.

20. A system, comprising:
a processor; and
a memory unit including instructions that when executed, cause the processor to:
vary a number of applications to be concurrently run on client devices to force poor quality of experience (QoE) to be experienced by client devices served by an access point (AP) operative in a network;
execute the applications at the client devices;
collect telemetry data from the AP, and measure QoE, the telemetry data being associated with the execution of the applications; and
train a QoE model with the telemetry data and the measured QoE to be operationalized for maximizing overall QoE across a plurality of traffic flows traversing the AP and QoE parity as applied to individual ones of the plurality of traffic flows, each of the plurality of traffic flows being associated with one of the number of applications executed at the client devices.
